(19) United States
(12) Patent Application Publication
(10) Pub. No.: US 2008/0144591 A1
(43) Pub. Date: Jun. 19, 2008

(54) Apparatus, methods, and computer program products providing FBMS with multiple BSSID support

(75) Inventor: Jari Jokela, Ylojarvi (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 12/002,726

(22) Filed: Dec. 17, 2007

Related U.S. Application Data
(60) Provisional application No. 60/875,771, filed on Dec. 18, 2006.

(51) Int. Cl. H04Q 7/24

(52) U.S. Cl. 370/338

(57) ABSTRACT

The exemplary embodiments of the invention enable a terminal to have access to or to obtain additional information (e.g., AID 0 Info information/FBMS Descriptor information) for non-transmitted beacons such that the terminal can fully utilize FBMS. In an exemplary embodiment of the invention, a method includes: providing a multiple basic service set identifier (BSSID) element including an information element defining information about buffered broadcast/multicast frames for a non-transmitting access point; and transmitting a message having the multiple BSSID element. In further exemplary embodiments, the information element comprises a FBMS Descriptor element or an association identifier (AID) 0 Info information element. In further exemplary embodiments, the message is a beacon or probe response.

### CROSS-REFERENCE TO RELATED APPLICATIONS

This patent application claims priority under 35 U.S.C. §119(e) from Provisional Patent Application No. 60/875,771, filed Dec. 18, 2006, the disclosure of which is incorporated by reference herein in its entirety.

### TECHNICAL FIELD

The teachings in accordance with the exemplary embodiments of this invention relate generally to wireless communication systems and, more specifically, relate to Flexible Broadcast/Multicast Service (FBMS) in wireless local area networks (WLANs).

### BACKGROUND

IEEE P802.11v™/D0.05 (802.11v) is a draft amendment to the 802.11 standard and is currently under consideration. IEEE P802.11v™/D0.05, “Draft Amendment to Standard for Information Technology—Telecommunications and Information Exchange Between Systems—LAN/MAN Specific Requirements—Part 11: Wireless Medium Access Control (MAC) and physical layer (PHY) specifications, Amendment v: Wireless Network Management,” Sep. 21, 2006. 802.11v provides Wireless Network Management enhancements to the 802.11 MAC and PHY, to extend prior work in radio measurement to effect a more complete and coherent upper layer interface for managing 802.11 devices in wireless networks. 802.11v, Abstract. The disclosure of the IEEE P802.11v™/D0.05 draft amendment is incorporated by reference herein in its entirety. Furthermore, the ANSI/IEEE Std 802.11, 1999 Edition (R2003), Part 11: Wireless LAN Medium Access Control (MAC) and Physical Layer (PHY) Specifications (802.11), reaffirmed Jun. 12, 2003, is also incorporated by reference herein in its entirety. Specific reference, with respect to useful material for the below discussion, is made to Sections 7.2.1.4, 7.3 and 11.2 of 802.11.

802.11v proposes a new feature to support improved power management (i.e., power saving) in stand-by mode: Flexible Broadcast/Multicast Service (FBMS). 802.11v defines FBMS as: “A [ ] [s]ervice whereby a client can request a delivery interval longer than the normal DTIM interval for the purposes of lengthing [sic] the period of time a STA may be in power save state. Thus a client may not have to wake up at every DTIM interval in order to receive broadcast and multicast frames.” 802.11v, section 3.v.1. FBMS uses the AID [association identifier] 0 Info information element (i.e., FBMS Descriptor element, other suitable information element) in beacons to indicate whether there are buffered frames belonging to certain broadcast/multicast services.

FBMS was originally designed to be used either in a simple infrastructure case where no virtual APs (Access Point) are present or in a simple virtual AP scenario where each virtual AP sends its own beacon frame. 802.11v allows for the possibility of utilizing virtual AP functionality in such a way that all of the virtual APs do not have to send their own beacon. Some of the virtual AP beacons can be “non-transmitted.” The beacons of other, transmitting APs are used to carry information relating to the non-transmitted beacons. Some of the non-transmitted beacon information is carried in a Multiple BBSID and in Multiple BBSID Index elements.

Note that “[a] ‘Virtual Access Point’ is a logical entity that exists within a physical Access Point (AP). When a single physical AP supports multiple ‘Virtual APs’, each Virtual AP appears to stations (STAs) to be an independent physical AP, even though only a single physical AP is present. For example, multiple Virtual APs might exist within a single physical AP, each advertising a distinct SSID and capability set. Alternatively, multiple Virtual APs might advertise the same SSID but a different capability set—allowing access to be provided via Web Portal, WEP, and WPA simultaneously. Where APs are shared by multiple providers, Virtual APs provide each provider with separate authentication and accounting data for their users, as well as diagnostic information, without sharing sensitive management traffic or data between providers.” Bernard Aboba, “Virtual Access Points,” IEEE 802.11-03/154r1, March 2003.

### SUMMARY

In an exemplary embodiment of the invention, a method includes: providing a multiple basic service set identifier (BSSID) element comprising an information element defining information about buffered broadcast/multicast frames for a non-transmitting access point; and transmitting a message comprising the multiple BSSID element.

In another exemplary embodiment of the invention, a program storage device readable by a machine, tangibly embodying a program of instructions executable by the machine for performing operations, said operations including: providing a multiple basic service set identifier (BSSID) element comprising an information element defining information about buffered broadcast/multicast frames for a non-transmitting access point; and transmitting a message comprising the multiple BSSID element.

In another exemplary embodiment of the invention, an apparatus having: a processor configured to provide a multiple basic service set identifier (BSSID) element comprising an information element defining information about buffered broadcast/multicast frames for a non-transmitting access point; and a transmitter configured to transmit a message comprising the multiple BSSID element.

In another exemplary embodiment of the invention, an apparatus having: means for providing a multiple basic service set identifier (BSSID) element comprising an information element defining information about buffered broadcast/multicast frames for a non-transmitting access point; and means for transmitting a message comprising the multiple BSSID element.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a conventional AID 0 Info information element format, as described in Section 7.3.2.44 of 802.11v;

FIG. 2 shows an exemplary AID 0 Info information/FBMS Descriptor element format incorporating aspects of the invention;

FIG. 3 shows another exemplary AID 0 Info information/FBMS Descriptor element format incorporating aspects of the invention;

FIG. 4 shows a conventional Multiple BSSID element, as described in Section 7.3.2.41 of 802.11v;

FIG. 5 depicts a non-transmitted BSSID Profile, as described in Section 7.3.2.41 of 802.11v;

FIG. 6 illustrates an exemplary non-transmitted BSSID Profile incorporating aspects of the invention;

FIG. 7 shows a simplified block diagram of various electronic devices that are suitable for use in practicing the exemplary embodiments of this invention;

FIG. 8 depicts a flowchart illustrating one non-limiting example of a method for practicing the exemplary embodiments of this invention;

FIG. 9 depicts a flowchart illustrating another non-limiting example of a method for practicing the exemplary embodiments of this invention;

FIG. 10 depicts a flowchart illustrating another non-limiting example of a method for practicing the exemplary embodiments of this invention; and

FIG. 11 depicts a flowchart illustrating another non-limiting example of a method for practicing the exemplary embodiments of this invention.

### DETAILED DESCRIPTION

The non-transmitted beacon information carried by a Multiple BBSID and/or by Multiple BBSID Index elements does not necessarily contain all of the available information. For example, the AID 0 information of a non-transmitted beacon is unavailable. If the AID 0 Info information, or other necessary information, is unavailable to the terminal, the terminal will not be able to fully utilize FBMS.

The exemplary embodiments of the invention enable a terminal to have access to or to obtain additional information (e.g., AID 0 Info information/FBMS Descriptor information) for non-transmitted beacons such that the terminal can fully utilize FBMS.

While the exemplary embodiments will be described below in the context of a WLAN system, it should be appreciated that the exemplary embodiments of this invention are not limited for use with only this one particular type of wireless communication system, and that they may be used to advantage in other wireless communication systems.

If virtual AP functionality is employed, in accordance with the exemplary embodiments of the invention as described herein, information about buffered broadcast and multicast frames is delivered to non-AP stations regardless of the type of virtual AP implementation used.

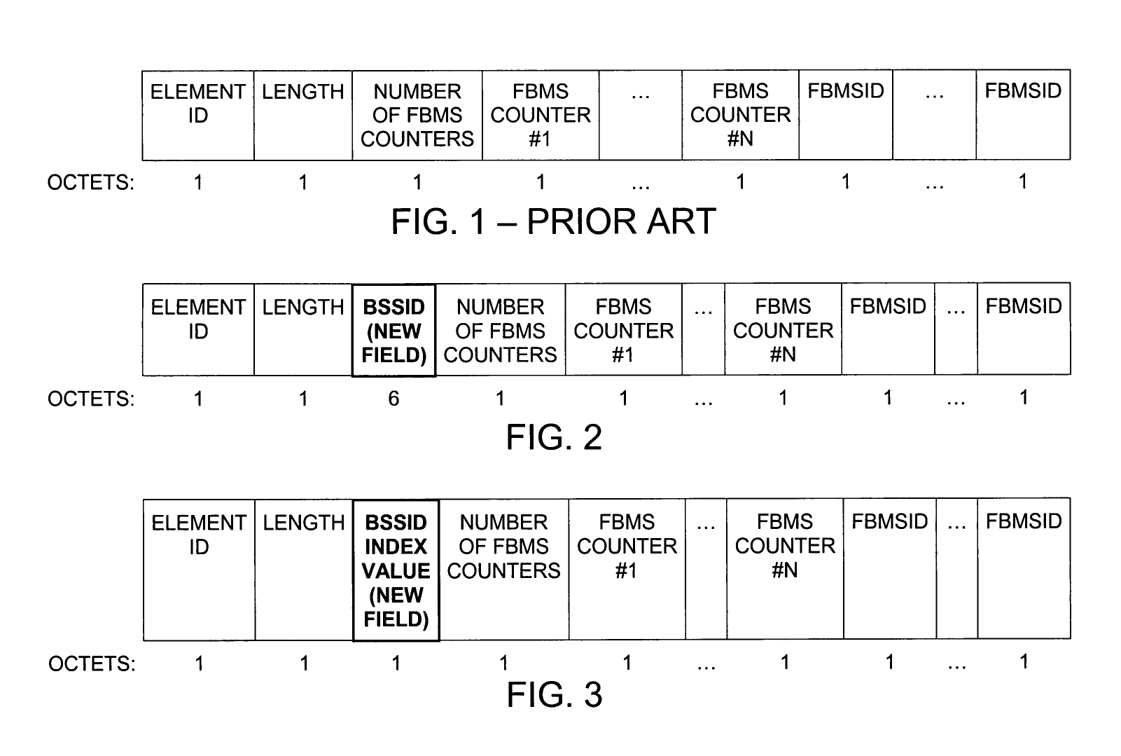

FIG. 1 shows a conventional AID 0 Info information element format, as described in Section 7.3.2.44 of 802.11v (D0.05). This section states: “The AID 0 Info defines information about the buffered Broadcast/Multicast frames. It may be present if dot11 WirelessManagementImplemented is true and if the AP supports FBMS. If there is no active FBMS stream then the AID 0 Info IE is not included in the Beacon frame.”

In a first exemplary aspect of the invention, BSSID information is added to (i.e., included in) the AID 0 Info information/FBMS Descriptor element to explicitly identify the virtual AP to which it is referring. In this case, a separate AID 0 Info information/FBMS Descriptor element is sent for each BSSID (either transmitted or non-transmitted) if the TIM field indicates there are buffered broadcast or multicast frames for the BSSID. FIG. 2 shows an exemplary AID 0 Info information/FBMS Descriptor element format incorporating aspects of the invention. In FIG. 2, the emphasized field comprises the included BSSID information.

Although shown in FIG. 2 as the third field in the exemplary AID 0 Info information element, in other embodiments the BSSID field may be located at a different position within the AID 0 Info information element. In further embodiments, the length of the BSSID field may comprise a value greater than or less than 6 octets. In other embodiments, the new field may be omitted from the AID 0 Info information element if Multiple BSSID and Multiple BSSID Index elements are not present in the beacon.

In a second exemplary aspect of the invention, a BSSID Index value is added to (i.e., included in) the AID 0 Info information/FBMS Descriptor element to identify the BSSID to which the element belongs. Also in this case, a separate AID 0 Info information/FBMS Descriptor element is sent for each BSSID (either transmitted or non-transmitted) if the TIM field indicates that there are buffered broadcast or multicast frames for the BSSID. FIG. 3 shows another exemplary AID 0 Info information/FBMS Descriptor element format incorporating aspects of the invention. In FIG. 3, the emphasized field comprises the included BSSID Index value. Note that the BSSID Index value is as defined in Section 7.3.2.43 of 802.11v.

Although shown in FIG. 3 as the third field in the exemplary AID 0 Info information element, in other embodiments the BSSID Index field may be located at a different position within the AID 0 Info information element. In further embodiments, the length of the BSSID field may comprise a value greater than 1 octet. In other embodiments, the new field may be omitted from the AID 0 Info information element if Multiple BSSID and Multiple BSSID Index elements are not present in the beacon.

Section 11.15.5 of 802.11v states: “An AP supporting Multiple BSSIDs indicates support of this service by including the Multiple BSSID Element in the beacon. A Multiple BSSID Element may consist of one or more multiple non-transmitted BSSID profiles. The non-transmitted BSSID profile shall include the SSID element and Multiple BSSID-Index element for each of the supported BSSIDs. All other elements are optional. Since the Multiple BSSID element is also present in probe response frames, an AP may choose to advertise the complete profile of a BSS corresponding to a Non-transmitted BSSID only in the probe response frames. In addition, the AP may choose to only include a partial list of non-transmitted BSSID profiles in the beacon or to include different sets of non-transmitted BSSID profiles in different beacon frames.”

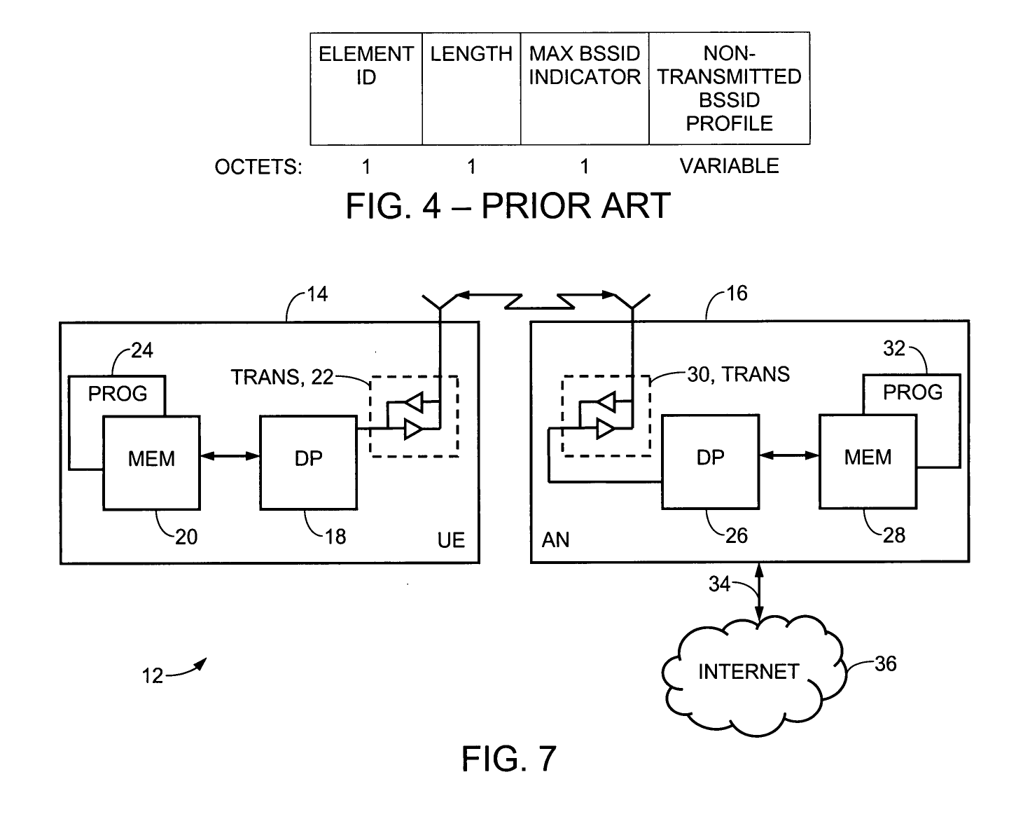

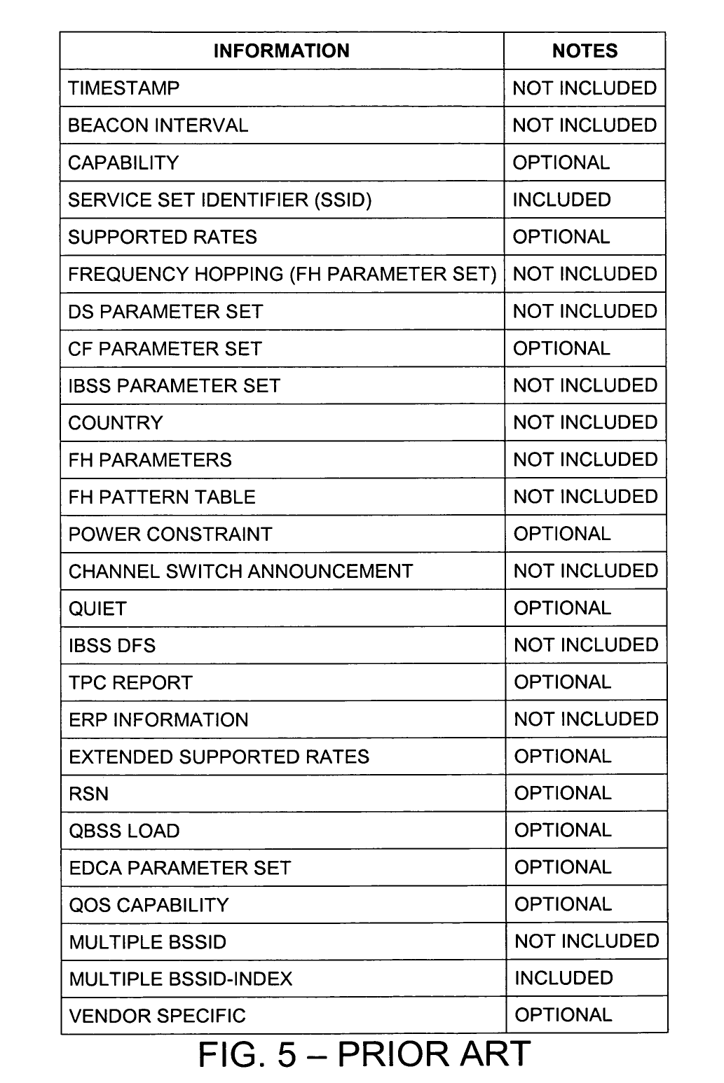

FIG. 4 shows a conventional Multiple BSSID element, as described in Section 7.3.2.41 of 802.11v. FIG. 5 depicts a Non-Transmitted BSSID Profile, as described in Section 7.3.2.41 of 802.11v.

This section of 802.11v states: “As shown in Table v43 [FIG. 5], the Non-Transmitted BSSID [basic service set identifier] profile may include the Capability, Supported Rates, CF Parameter Set, Power Constraint, Quiet, TPC Report, Extended Supported Rates, RSN and Vendor Specific information element fields for each non-transmitted BSSID. The Timestamp, Beacon Interval, DS Parameter Set, FH Parameter Set, IBSS Parameter Set, Country, FH Parameters, FH Pattern Table, Channel Switch Assignment, IBSS DFS, and ERP Information element values for each non-transmitted BSSID is not included in the Multiple BSSID element, and is always the transmitted BSSID element values.”

Section 7.3.2.41 further states: “The Multiple BSSID-Index field includes the DTIM Count and DTIM Period for the non-transmitted BSSIDs. When the Multiple BSSID element is present in the probe request frame, one or more of the SSID elements may have a NULL SSID or zero IE length to indicate a broadcast probe request.”

As can be seen, the AID 0 Info information element of a non-transmitted beacon is not provided in a conventional Multiple BSSID element.

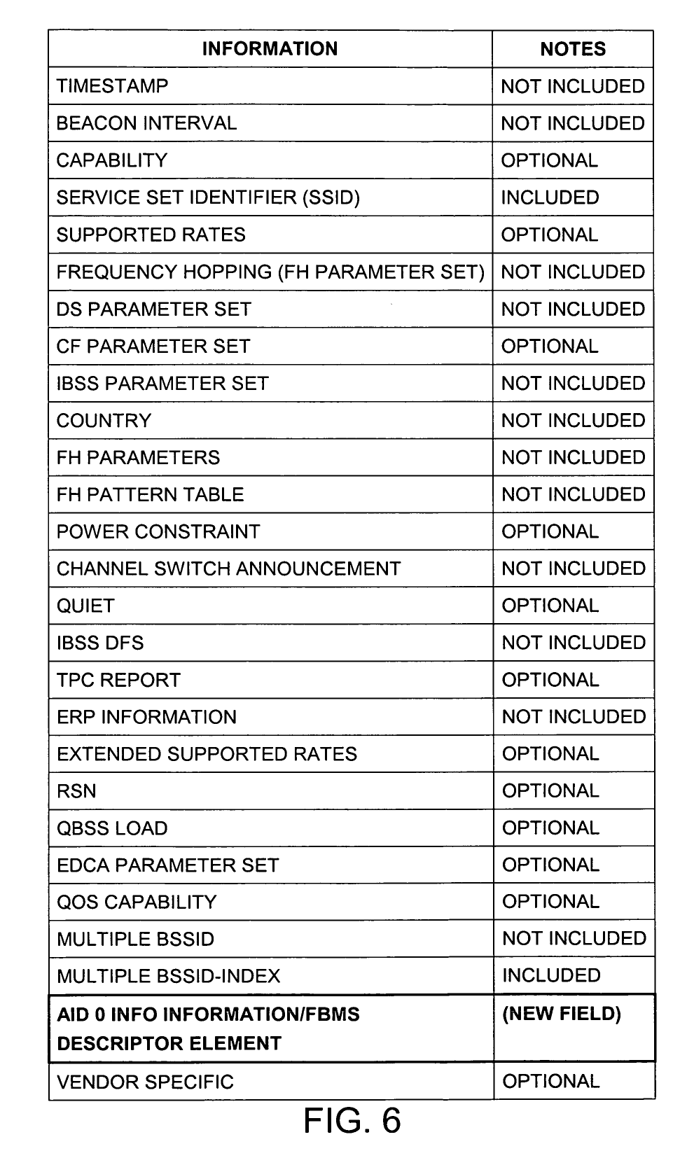

In a third exemplary aspect of the invention, the AID 0 Info information/FBMS Descriptor element is added to (i.e., included in) the Non-Transmitted BSSID Profile field of the Multiple BSSID element (e.g., by adding the AID 0 Info information/FBMS Descriptor element to the non-transmitted BSSID Profile). FIG. 6 illustrates an exemplary Non-Transmitted BSSID Profile incorporating aspects of the invention. In other embodiments, the BSSID Profile may comprise a different plurality of fields. In further embodiments, the AID 0 Info information element may be located at a different location within the Non-Transmitted BSSID Profile.

In a fourth exemplary aspect of the invention, separate FBMSIDs are used for different virtual APs. In such a manner, the streams can be separated without modifying the AID 0 Info information/FBMS Descriptor element, the Multiple BSSID element or the non-transmitted BSSID Profile. In this case, the AP must ensure that all BSSIDs have separate sets of FBMSIDs (i.e., the AP may have more than one FBMSID for each BSSID). Note that a set of FBMSIDs comprises at least one FBMSID and, in some cases, may comprise only one FBMSID.

Reference is made to FIG. 7 for illustrating a simplified block diagram of various exemplary electronic devices that are suitable for use in practicing the exemplary embodiments of this invention. In FIG. 7, a wireless network 12 is adapted for communication with a user equipment (UE) 14 via an access node (AN) 16. The UE 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 has at least one antenna to facilitate communication.

The AN 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18,26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

As can be seen, the exemplary embodiments of the invention enable a terminal to have access to or to obtain additional information (e.g., the AID 0 Info information/FBMS Descriptor element) for non-transmitted beacons such that the terminal can fully utilize FBMS.

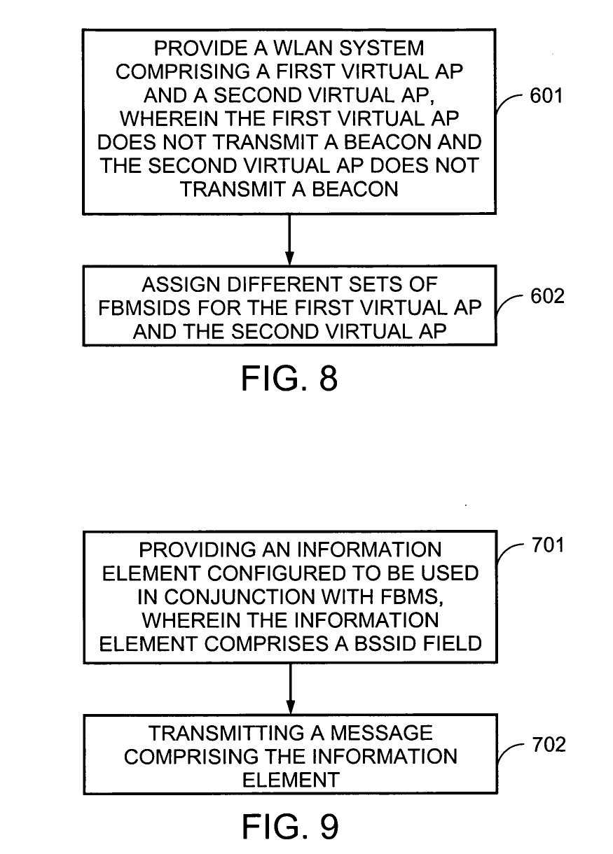

In one non-limiting, exemplary embodiment, and as shown in FIG. 8, a method includes: providing a WLAN system comprising a first virtual AP and a second virtual AP, wherein the first virtual AP does not transmit a beacon and the second virtual AP does not transmit a beacon (box 601); and assigning different sets of FBMSIDs for the first virtual AP and the second virtual AP (box 602).

In another non-limiting, exemplary embodiment, an AID 0 Info information/FBMS Descriptor element is provided. The element is used in conjunction with FBMS in a WLAN system and comprises a BSSID field. In another exemplary embodiment, the element comprises: an Element ID field, a length field, a BSSID field, a Number of FBMS Counters field, at least one FBMS Counter field and at least one FBMSID field. In a further exemplary embodiment, the BSSID field is omitted (or not present) if Multiple BSSID and Multiple BSSID Index elements are not present in the beacon.

As a non-limiting example, and as shown in FIG. 9, a method comprising: providing an information element configured to be used in conjunction with FBMS (e.g., in a WLAN), wherein the information element comprises a BSSID field (box 701); and transmitting a message comprising the information element (box 702). In further exemplary embodiments, the information element comprises an AID 0 Info information element or a FBMS Descriptor element.

In another non-limiting, exemplary embodiment, an AID 0 Info information/FBMS Descriptor element is provided. The element is used in conjunction with FBMS in a WLAN system and comprises a BSSID Index value. In another exemplary embodiment, the element comprises: an Element ID field, a length field, a BSSID Index value, a Number of FBMS Counters field, at least one FBMS Counter field and at least one FBMSID field. In a further exemplary embodiment, the BSSID Index value is omitted (or not present) if Multiple BSSID and Multiple BSSID Index elements are not present in the beacon.

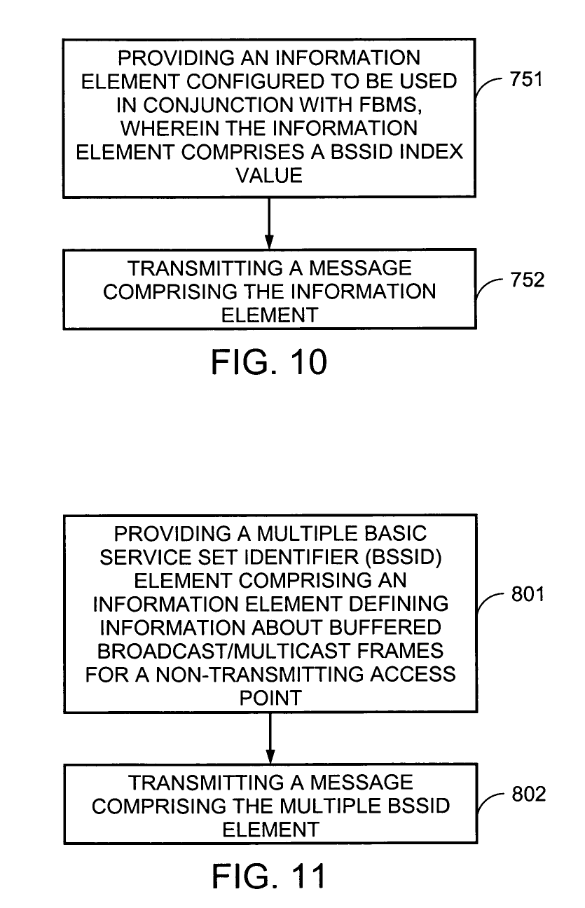

As a non-limiting example, and as shown in FIG. 10, a method comprising: providing an information element configured to be used in conjunction with FBMS (e.g., in a WLAN), wherein the information element comprises a BSSID Index value (box 751); and transmitting a message comprising the information element (box 752). In further exemplary embodiments, the information element comprises an AID 0 Info information element or a FBMS Descriptor element.

In another non-limiting, exemplary embodiment, a Multiple BSSID element is provided. The Multiple BSSID element is used in conjunction with FBMS in a WLAN system and comprises an AID 0 Info information/FBMS Descriptor element. In other exemplary embodiments, the Multiple BSSID element comprises a Non-Transmitted BSSID Profile comprising an AID 0 Info information element.

As a non-limiting example, and as shown in FIG. 11, a method comprising: providing a multiple basic service set identifier (BSSID) element comprising an information element defining information about buffered broadcast/multicast frames for a non-transmitting access point (box 801); and transmitting a message comprising the multiple BSSID element (box 802). A method as in the previous, wherein the information element comprises a FBMS Descriptor element. A method as in any above, wherein the information element comprises an association identifier (AID) 0 Info information element. A method as in any above, wherein the multiple BSSID comprises a non-transmitted BSSID profile field comprising the information element. A method as in any above, wherein the non-transmitted BSSID profile field corresponds to the non-transmitting access point. A method as in any above, wherein the message comprises a beacon or a probe response. A method as in any above, wherein the message is transmitted from a transmitting access point (e.g., of the FBMS). A method as in any above, wherein the multiple BSSID element is for a flexible broadcast/multicast service (FBMS) with a non-transmitting access point. A method as in any above, wherein the FBMS is ongoing within a wireless local area network. A method as in any above, wherein the method is implemented by a computer program. A method as in any above, wherein the method is implemented by a program storage device readable by a machine, tangibly embodying a program of instructions executable by the machine for performing operations, said operations comprising the steps of the method.

As another non-limiting example, a program storage device readable by a machine, tangibly embodying a program of instructions executable by the machine for performing operations, said operations comprising: providing a multiple basic service set identifier (BSSID) element comprising an information element defining information about buffered broadcast/multicast frames for a non-transmitting access point; and transmitting a message comprising the multiple BSSID element. A program storage device as in the previous, wherein the information element comprises a FBMS Descriptor element. A program storage device as in any above, wherein the information element comprises an association identifier (AID) 0 Info information element. A program storage device as in any above, wherein the multiple BSSID comprises a non-transmitted BSSID profile field comprising the information element. A program storage device as in any above, wherein the non-transmitted BSSID profile field corresponds to the non-transmitting access point. A program storage device as in any above, wherein the message comprises a beacon or a probe response. A method as in any above, wherein the message is transmitted from a transmitting access point (e.g., of the FBMS). A program storage device as in any above, wherein the multiple BSSID element is for a flexible broadcast/multicast service (FBMS) with a non-transmitting access point. A program storage device as in any above, wherein the FBMS is ongoing within a wireless local area network.

As a further non-limiting example, an apparatus comprising: a processor configured to provide a multiple basic service set identifier (BSSID) element comprising an information element defining information about buffered broadcast/multicast frames for a non-transmitting access point; and a transmitter configured to transmit a message comprising the multiple BSSID element. An apparatus as in the previous, wherein the information element comprises a FBMS Descriptor element. An apparatus as in any above, wherein the information element comprises an association identifier (AID) 0 Info information element. An apparatus as in any above, wherein the multiple BSSID comprises a non-transmitted BSSID profile field comprising the information element. An apparatus as in any above, wherein the non-transmitted BSSID profile field corresponds to the non-transmitting access point. An apparatus as in any above, wherein the message comprises a beacon or a probe response. An apparatus as in any above, wherein the message is transmitted from a transmitting access point (e.g., of the FBMS). An apparatus as in any above, wherein the multiple BSSID element is for a flexible broadcast/multicast service (FBMS) with a non-transmitting access point. An apparatus as in any above, wherein the FBMS is ongoing within a wireless local area network. An apparatus as in any above, wherein the apparatus comprises a mobile electronic device. An apparatus as in any above, wherein the apparatus comprises a mobile terminal.

As another non-limiting example, an apparatus comprising: means for providing a multiple basic service set identifier (BSSID) element comprising an information element defining information about buffered broadcast/multicast frames for a non-transmitting access point; and means for transmitting a message comprising the multiple BSSID element. An apparatus as in the previous, wherein the means for providing comprises a processor and the means for transmitting comprises a transmitter. An apparatus as in any above, wherein the information element comprises a FBMS Descriptor element. An apparatus as in any above, wherein the information element comprises an association identifier (AID) 0 Info information element. An apparatus as in any above, wherein the multiple BSSID comprises a non-transmitted BSSID profile field comprising the information element. An apparatus as in any above, wherein the non-transmitted BSSID profile field corresponds to the non-transmitting access point. An apparatus as in any above, wherein the message comprises a beacon or a probe response. An apparatus as in any above, wherein the message is transmitted from a transmitting access point (e.g., of the FBMS). An apparatus as in any above, wherein the multiple BSSID element is for a flexible broadcast/multicast service (FBMS) with a non-transmitting access point. An apparatus as in any above, wherein the FBMS is ongoing within a wireless local area network. An apparatus as in any above, wherein the apparatus comprises a mobile electronic device. An apparatus as in any above, wherein the apparatus comprises a mobile terminal.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the non-limiting and exemplary embodiments of this invention.

Furthermore, some of the features of the preferred embodiments of this invention could be used to advantage without the corresponding use of other features. As such, the foregoing description should be considered as merely illustrative of the principles, teachings and exemplary embodiments of this invention, and not in limitation thereof.

What is claimed is:

1. A method comprising:
providing a multiple basic service set identifier (BSSID) element comprising an information element defining information about buffered broadcast/multicast frames for a non-transmitting access point; and
transmitting a message comprising the multiple BSSID element.

2. A method as in claim 1, wherein the information element comprises a FBMS Descriptor element.

3. A method as in claim 1, wherein the information element comprises an association identifier (AID) 0 Info information element.

4. A method as in claim 1, wherein the multiple BSSID comprises a non-transmitted BSSID profile field comprising the information element.

5. A method as in claim 4, wherein the non-transmitted BSSID profile field corresponds to the non-transmitting access point.

6. A method as in claim 1, wherein the message comprises a beacon or a probe response.

7. A method as in claim 1, wherein the message is transmitted from a transmitting access point.

8. A method as in claim 1, wherein the multiple BSSID element is for a flexible broadcast/multicast service (FBMS) with a non-transmitting access point

9. A method as in claim 8, wherein the FBMS is ongoing within a wireless local area network.

10. A program storage device readable by a machine, tangibly embodying a program of instructions executable by the machine for performing operations, said operations comprising:
providing a multiple basic service set identifier (BSSID) element comprising an information element defining information about buffered broadcast/multicast frames for a non-transmitting access point; and
transmitting a message comprising the multiple BSSID element.

11. A program storage device as in claim 10, wherein the information element comprises a FBMS Descriptor element.

12. A program storage device as in claim 10, wherein the information element comprises an association identifier (AID) 0 Info information element.

13. A program storage device as in claim 10, wherein the multiple BSSID comprises a non-transmitted BSSID profile field comprising the information element.

14. A program storage device as in claim 13, wherein the non-transmitted BSSID profile field corresponds to the non-transmitting access point.

15. A program storage device as in claim 10, wherein the message comprises a beacon or a probe response.

16. A program storage device as in claim 10, wherein the message is transmitted from a transmitting access point.

17. A program storage device as in claim 10, wherein the multiple BSSID element is for a flexible broadcast/multicast service (FBMS) with a non-transmitting access point

18. A program storage device as in claim 17, wherein the FBMS is ongoing within a wireless local area network.

19. An apparatus comprising:
a processor configured to provide a multiple basic service set identifier (BSSID) element comprising an information element defining information about buffered broadcast/multicast frames for a non-transmitting access point; and
a transmitter configured to transmit a message comprising the multiple BSSID element.

20. An apparatus as in claim 19, wherein the information element comprises a FBMS Descriptor element.

21. An apparatus as in claim 19, wherein the information element comprises an association identifier (AID) 0 Info information element.

22. An apparatus as in claim 19, wherein the multiple BSSID comprises a non-transmitted BSSID profile field comprising the information element.

23. An apparatus as in claim 23, wherein the non-transmitted BSSID profile field corresponds to the non-transmitting access point.

24. An apparatus as in claim 19, wherein the message comprises a beacon or a probe response.

25. An apparatus as in claim 19, wherein the message is transmitted from a transmitting access point.

26. An apparatus as in claim 19, wherein the multiple BSSID element is for a flexible broadcast/multicast service (FBMS) with a non-transmitting access point

27. An apparatus as in claim 26, wherein the FBMS is ongoing within a wireless local area network.

28. An apparatus as in claim 19, wherein the apparatus comprises a mobile electronic device.

29. An apparatus as in claim 19, wherein the apparatus comprises a mobile terminal.

30. An apparatus comprising:
means for providing a multiple basic service set identifier (BSSID) element comprising an information element defining information about buffered broadcast/multicast frames for a non-transmitting access point; and
means for transmitting a message comprising the multiple BSSID element.

31. An apparatus as in claim 30, wherein the means for providing comprises a processor and the means for transmitting comprises a transmitter.

32. An apparatus as in claim 30, wherein the information element comprises a FBMS Descriptor element.

33. An apparatus as in claim 30, wherein the multiple BSSID comprises a non-transmitted BSSID profile field comprising the information element.

34. An apparatus as in claim 30, wherein the multiple BSSID element is for a flexible broadcast/multicast service (FBMS) with a non-transmitting access point

35. An apparatus as in claim 34, wherein the FBMS is ongoing within a wireless local area network.

36. An apparatus as in claim 30, wherein the apparatus comprises a mobile terminal.
